(19) United States
(12) Patent Application Publication
(10) Pub. No.: US 2014/0269438 A1
(43) Pub. Date: Sep. 18, 2014

(54) APPARATUS AND METHODS FOR CONDUCTING COMMUNICATIONS WITH A TELEPHONY DEVICE THAT IS ASSIGNED MULTIPLE IDENTIFIERS ASSOCIATED WITH DIFFERENT GEOGRAPHICAL REGIONS

(71) Applicant: VONAGE NETWORK, LLC, HOLMDEL, NJ (US)

(72) Inventors: Alan Ronald BUGOS, WESTFORD, MA (US); Jeffrey MARKS, WINTER SPRINGS, FL (US); Michael TRUETT, LONG BEACH, NJ (US)

(73) Assignee: VONAGE NETWORK, LLC, HOLMDEL, NJ (US)

(21) Appl. No.: 13/835,357

(22) Filed: Mar. 15, 2013

(51) Int. Cl. H04M 15/00

(52) U.S. Cl. CPC H04M 15/56
USPC 370/259

(57) ABSTRACT

A telephony device is assigned two telephone numbers, a first telephone number from a first country and a second telephone number from a second country. When a user places an outgoing call to a telephone number in the first country, the caller ID information indicates that the call is originating from the first telephone number associated with the first country. Also, the user is charged only the local termination rates for calls in the first country, regardless of where the telephony device is located when the call is placed. When the user places an outgoing call to a telephone number in the second country, the caller ID information indicates that the call originated from the second telephone number, associated with the second country. Also, the user is charged only the standard local termination rates for calls in the second country, regardless of where the telephony device is located when the call is placed.

### BACKGROUND OF THE INVENTION

The invention is related to Internet Protocol (IP) telephony systems. More specifically, the invention is related to telephony devices and methods of routing telephony communications via an IP telephony system.

When a user registers for service with a telephony service provider such as a typical publically switched telephone network (PSTN), the telephony service provider assigns a telephone number to the user. If the user is making use of telephones located in an office or a residence, the telephone number is usually associated with a physical line that terminates in the residence or business, and one or more telephony devices connected to that line can receive calls placed to the assigned telephone number. Likewise, outgoing calls placed from one of the telephony devices reflect the assigned telephone number as the originating telephone number of the outgoing call.

When a user registers for service with a typical cellular or mobile telephony service provider, the service provider assigns a telephone number to the user. The user can then register a specific mobile telephony device under the user's account. Calls to the assigned telephone number are terminated to the registered mobile telephony device. Likewise, outgoing calls from the mobile telephony device reflect the assigned telephone number as the originating telephone number of the outgoing call.

When a user places an outgoing call with a telephony device registered with a PSTN or a mobile telephony device registered with a mobile telephony service provider, the service provider is responsible for setting up the call to the dialed party. The service provider then charges the user for the cost of setting up the call. The charges can vary considerably, depending on the geographical location of the called party. This reflects the fact that it is more expensive for a PSTN or a mobile telephony service provider to terminate a call to a called party that is located far away, as opposed to a called party that is nearby. In addition, in the case of an outgoing call to a different geographical region, it is often necessary for the service provider to enlist the help of a different service provider in that region to help terminate the call to the called party. The cost of obtaining assistance from the other service provider adds to the cost of completing the call.

A first party registered with a PSTN or a mobile telephony service provider located in a first geographical region can often receive incoming calls at no cost, regardless of where the calling party is located. However, if the calling party is located in a second geographical region that is relatively far away, the calling party must pay high rates to reach the first party.

IP telephony systems also allow users to place and receive telephone calls and to send and/or receive other types of communications. The communications are transmitted, at least in part, by data packets that traverse a private and/or public data network. Because the cost of sending data packets over a data network is quite small, it is often possible for an IP telephony service provider to offer low rates to its customers for completing telephone calls to geographical locations that are far away.

However, when a first calling party in first geographical region that is registered with a PSTN or mobile telephony service provider in that first region wishes to place a call to a second party in a second geographical region, even if the second party receives service from an IP telephony service provider, the calling party must still pay the relatively high rates for placing the long distance call. This is true, despite the fact that that the second (called) party could place an outgoing call to the first party for a lower rate, as offered by the IP telephony service provider.

What is needed is a simple way for a customer of an IP telephony service provider located in a first geographical region to make use of the IP telephony service providers' network to receive incoming calls from other geographical regions, such that the overall cost of completing incoming calls can be lowered. In most instances, this will make it less expensive for others in different geographical regions to place a call to the customer of the IP telephony service provider.

### BRIEF DESCRIPTION OF THE DRAWINGS

FIG. 1 is a diagram of a communications environment including various elements which are associated with an Internet protocol (IP) telephony system operating in accordance with one embodiment of the invention;

FIG. 2 is a diagram of various elements of a processor that forms part of a telephony device or an IP telephony system in accordance with one embodiment of the invention;

FIG. 3 is a block diagram illustrating elements of a telephony device which can be assigned multiple identifiers from different geographical regions in accordance with one embodiment of the invention;

FIG. 4 is a diagram illustrating selected elements of an IP telephony system which is capable of routing communications to and from a telephony device which has been assigned multiple identifiers from different geographical regions in accordance with one embodiment of the invention;

FIG. 5 is a diagram illustrating the paths traversed by telephony communications which are traveling to and from a telephony device which has been assigned multiple identifiers from different geographical regions in accordance with one embodiment of the invention;

FIG. 6 is a flow diagram illustrating steps of a method performed by a telephony device that has been assigned multiple identifiers from different geographical regions as the telephony device sets up and conducts an outgoing communication in accordance with one embodiment of the invention;

FIG. 7 is a flow diagram of a first method performed by an IP telephony system to assist a telephony device which has been assigned multiple identifiers from different geographical regions in setting up and conducting an outgoing communication in accordance with one embodiment of the invention; and

FIG. 8 is a flow diagram of a second method performed by an IP telephony system to assist a telephony device which has been assigned multiple identifiers from different geographical regions in setting up and conducting an outgoing communication in accordance with one embodiment of the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VoIP system, VoIP telephony system, IP system and IP telephony system are all intended to refer to a system that connects callers and that delivers data, text or video communications using Internet protocol data communications.

As illustrated in FIG. 1, a communications environment 100 is provided to facilitate IP based communications. A first IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to both a first publicly switched telephone network (PSTN) 130 located in a first country, and a second PSTN 140 located in a second country via one or more gateways 122.

The gateway 122 allows users and devices that are connected to the first and second PSTNs 130, 140 to connect with users and devices that are reachable through the first IP telephony system 120, and vice versa. In some instances, the gateway 122 would be a part of the first IP telephony system 120. In other instances, the gateway 122 could be maintained by a third party.

Customers of the first IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a cellular telephone system to access the Internet 110.

Alternatively, a customer could utilize an analog telephone 102a which is connected to the Internet 110 via a terminal adaptor 104. The terminal adaptor 104 converts analog signals from the telephone 102a into data signals that pass over the Internet 110, and vice versa. Also, as illustrated in FIG. 1, multiple analog telephones 102a and 102b could all be coupled to the same terminal adaptor 104. Analog telephone devices include, but are not limited to, standard telephones and document imaging devices such as facsimile machines. A configuration using a terminal adaptor 104 is common where all of the analog telephones 102a, 102b are located in a residence or business, and all of the telephones are connected to the same terminal adaptor. With this configuration, all of the analog telephones 102a, 102b share the same telephone number assigned to the terminal adaptor 104. Other configurations are also possible where multiple communication lines (e.g., a second telephone number) are provisioned by the IP telephony system 120.

In addition, a customer could utilize a soft-phone client running on a computer 106 to place and receive IP based telephone calls, and to access other IP telephony systems. In some instances, the soft-phone client could be assigned its own telephone number. In other instances, the soft-phone client could be associated with a telephone number that is also assigned to an IP telephone 108, or to a terminal adaptor 104 that is connected to one or more analog telephones 102a, 102b.

A third party using the first analog telephone 132 which is connected to the first PSTN 130 may call a customer of the IP telephony system 120. In this instance, the call is initially connected from the first analog telephone 132 to the first PSTN 130, and then from the first PSTN 130, through the gateway 122 to the first IP telephony system 120. The first IP telephony system 120 then routes the call to the customer's IP telephony device. A third party using the first cellular telephone 134 could also place a call to an IP telephony system customer, and the connection would be established in a similar manner, although the first link would involve communications between the first cellular telephone 134 and a cellular telephone network. For purposes of this explanation, the cellular telephone network is considered part of the first PSTN 130.

In addition, mobile computing devices which include cellular telephony capabilities could also be used to place telephone calls to customers of the IP telephony system. A first mobile computing device 136, as illustrated in FIG. 1, might connect to the first PSTN 130 using its cellular telephone capabilities. However, such devices might also have the ability to connect wirelessly via some other means. For example, the mobile computing device 136 might communicate with a wireless data router to connect the first mobile computing device 136 directly to a data network, such as the Internet 110. In this instance, communications between the first mobile computing device 136 and other parties could be entirely carried by data communications which pass from the first mobile computing device 136 directly to a data network 110. Of course, alternate embodiments could utilize any other form of wired or wireless communications path to enable communications.

Users of the first IP telephony system 120 are able to access the service from virtually any location where they can connect to the Internet 110. Thus, a customer could register with an IP telephony system located in the U.S., and that customer could then use an IP telephone 108 located in a country outside the U.S. to access the services. Likewise, the customer could also utilize a computer outside the U.S. that is running a soft-phone client to access the first IP telephony system 120. Further, in some instances a user could place a telephone call with the first analog telephone 132 or first cellular telephone 134 that is routed through the first PSTN 130 to the first IP telephony system 120 via the gateway 122. This would typically be accomplished by the user calling a local telephone number that is routed to the first IP telephony system 120 via the gateway 122. Once connected to the first IP telephony system 120, the user may then place an outgoing long distance call to anywhere in the world using the first IP telephony system's network. Thus, the user is able place a long distance call using lower cost IP telephony service provided by the first IP telephony system 120, rather than a higher cost service provided by the first PSTN 130.

FIG. 1 also illustrates that a second IP telephony system 170 located in the second country may interact with the first IP telephony system 120 in the first country via the Internet 110. For example, customers of the second IP telephony system 170 may place calls to customers of the first IP telephony system 120. In that instance, assets of the second IP telephony system 170 interact with assets of the first IP telephony system 120 to setup and carry the telephone call. Conversely, customers of the first IP telephony system 120 can place calls to customers of the second IP telephony system 170. Because the IP telephony systems interact with each other over a data network, a first customer of the first IP telephony system 120 that is located in the first country can place a call to a second customer of the second IP telephony system 170 in the second country for a considerably lower cost than if a similar call were established through the first country PSTN 130 and second country PSTN 140.

The second IP telephony system could also interact with customers of a second PSTN 140 via a gateway 172. The second PSTN 140 may be connected to a second analog telephone 174, a second cellular telephone 176 and a second mobile computing device 178.

In the following description, we will assume that the first IP telephony system 120, the first PSTN 130, the IP telephone 108, the VoIP adaptor 104, the first analog telephone 132, the first cellular telephone 134 and the first mobile computing device 136 are all located in a first country. Also, the second IP telephony system 170, the second PSTN 140, the second analog telephone 174, the second cellular telephone 176 and the second mobile computing device 178 are all located in a second country.

FIG. 2 illustrates elements of a computer processor 250 that can be used as part of the first or second IP telephony systems 120, 170, or as part of an IP telephony device, to accomplish various functions. Each of the IP telephony systems 120, 170, or an IP telephony device, could include multiple processors 250, along with their operating components and programming, each carrying out a specific or dedicated function.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of an IP telephony system 120/170 or an IP telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

In the following description, references will be made to an “IP telephony device.” This term is used to refer to any type of device which is capable of interacting with an IP telephony system to complete a telephone call. An IP telephony device could be an IP telephone, a computer running IP telephony software, a terminal adaptor which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch™ can interact with an IP telephony system to conduct a telephone call.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VoIP telephony system. In other words, these terms are intended to encompass any communications whatsoever, in any format, which traverse all or a portion of a communications network or telephony network.

As explained above, a customer of an IP telephony system can receive services from the IP telephony system simply by connecting their IP telephony device to the Internet. It does not matter where the IP telephony device is physically located. So long as the customer's IP telephony device is able to establish a quality data link to the IP telephony system, the IP telephony system can setup outgoing calls for the customer to virtually any geographical location. Likewise, the IP telephony system can route incoming calls intended for the customer to the customer's IP telephony device, regardless of where the calls originate. These aspects of the IP telephony system are exploited to reduce the cost paid by calling parties to reach the customer, as explained below.

In systems and methods embodying the invention, a customer's telephony device is assigned multiple identifiers which are associated with different geographical regions. In some embodiments, the identifiers are telephone numbers. In alternate embodiments, the identifiers could be a different form of identifier which is used to contact the telephony device, and/or which can be used to identify the telephony device as the originator of a communication. Thus, the term “identifier” will be used in the generic sense to refer to any combination of characters, in addition to telephone numbers, which can be associated with a telephony device.

In systems and methods embodying the invention, a telephony device is assigned a first identifier that is associated with a first geographical region, and a second identifier that is associated with a second geographical region. Where the identifiers are telephone numbers, this would mean that the telephony device is assigned a first telephone number that conforms to the telephony numbering scheme in the first geographical region, and a second telephone number that conforms to the telephony numbering scheme in place in the second geographical region.

When a calling party located in the first country wishes to send a telephony communication to the customer's telephony device, the calling party uses a first identifier assigned to the customer's telephony device and that is associated with the first country. If the identifiers are telephone numbers, this could involve the calling party dialing a first telephone number that is assigned to the telephony device and that is associated with the first country. Because the telephone number is a normal telephone number for the first country, the calling party would pay the local rates for calls that originate and terminate within the first country.

If a calling party located in a second country wishes to send a telephony communication the customer's telephony device, the calling party uses the second identifier assigned to the customer's telephony device and that is associated with the second country. If the identifiers are telephone numbers, this could involve the calling party dialing a second telephone number that is assigned to the telephony device and that is associated with the second country. Because the second telephone number is a normal telephone number for the second country, the calling party would pay the local rates for calls that originate and terminate within the second country.

As explained above, it does not matter where the customer's telephony device is physically located. The telephony device could be located in the first country, and it could receive incoming calls that originate from calling parties located in both the first and the second countries. Likewise, the telephony device could be located in the second country, and the telephony device could receive calls that originate from calling parties located in the first and second counties. In fact, the telephony device could be located in a third country, and the telephony device could still receive incoming calls that originate from calling parties located in the first and second countries. Regardless of where the customer's telephony device is located, a calling party in the first country dials a local telephone number for the first country, and therefore only pays the rate for a local call that originates and terminates in the first country. Likewise, a calling party in the second country dials a local telephone number for the second country, and therefore is only charged the local rate for calls that originate and terminate in the second country.

The customer's telephony device could also be assigned identifiers associated with additional geographical regions. And callers in each geographical region would use the local identifier (such as a local telephone number) associated with their home geographical region to reach the customer's telephony device. As a result, the calling parties only pay local rates for reaching the customer's telephony device.

In addition, when the customer's telephony device is assigned multiple identifiers that are associated with different geographical regions, those identifiers can be selectively used to identify the customer's telephony device as the originator of an outgoing communication, depending on where the communication is directed.

For example, assume that a customer's telephony device is assigned a first telephone number associated with a first country, and a second telephone number associated with a second country. If the customer uses the telephony device to place an outgoing call, it would be possible for either of the two telephone numbers to be identified as the originator or calling party in caller ID information for the call. In systems and methods embodying the invention, when the customer places a call to a telephone number in the first country, the first telephone number assigned to the telephony device is presented in the caller ID information to identify the originating party. If the customer instead places a call to a telephone number in the second country, the second telephone number assigned to the customer's telephony device is presented in the caller ID information to identify the originating party. Thus, regardless of where the customer's telephony device is located, the call will appear to originate from within the called party's country. Also, if the called party captures the telephone number in the caller ID information, the called party can later place a return call to the customer's telephony device, using the local number for his home country.

In some instances, the customer may be charged for outgoing communications based on the local rates that are in effect in the called regions. For example, in some embodiments, when the customer places an outgoing call to a telephone number in the first country, the customer is charged the local rate for calls that originate and terminate in the first country. Likewise, if the customer calls a telephone number in the second country, the customer is charged the local rate for calls that originate and terminate in the second country.

In alternate embodiments, the customer may be charged different rates for placing calls to the first and second countries, and the rates may be based on where the customer originally signed up for service with the IP telephony system. For example, if the customer originally signed up for service in a first country, but identifiers for both the first and second countries are assigned to the customer's telephony device, the customer may be charged differently for calls to the first and second countries. Calls to telephone numbers in the first country would incur the local charges for calls that originate and terminate in the first country. But calls to the second country may result in higher charges that would apply for any calls made through the IP telephony system from the first country to the second country.

Some examples of systems and methods which can be used to implement the above-discussed functions will now be described with reference to FIGS. 3-8.

FIG. 3 illustrates elements of a telephony device 300 which is configured to accomplish portions of the above-discussed functions. The telephony device 300 includes a communication setup unit 302 and a device identifier database 304.

FIG. 4 illustrates selected elements of an IP telephony system 400 which performs some of the above-discussed functions. The IP telephony system 400 includes other elements in addition to those illustrated in FIG. 4. FIG. 4 shows that the IP telephony system 400 includes a communication setup unit 402, a device identifier database 404, a call detail record (CDR) unit 406, and a billing unit 408.

FIG. 5 illustrates a communications environment which can be used to accomplish and implement the above-discussed functions. The solid lines in FIG. 5 represent the paths traversed by both call setup signaling and some of the paths traversed by the media of a telephony communication. The dashed lines in FIG. 5 illustrate the paths traveled by data packets bearing the media of IP telephony communications. A description of how these elements interact with one another to accomplish the above-discussed functions will be provided in conjunction with the methods outlined in the flow charts in FIGS. 6-8.

FIG. 6 illustrates steps of a method 600 that is performed by a telephony device to set up an outgoing call. The telephony device is assigned multiple identifiers associated with different geographical regions. For purposes of the following discussion, we will assume that a customer is using a first IP telephony device 502 located in a first country to place a telephone call to a second IP telephony device 532 located in a second country. The first IP telephony device 502 is assigned a first identifier associated with the first country, and a second identifier associated with the second country.

The method 600 begins and proceeds to step S602, where information is received to identify the party or telephony device the customer wishes to call. This step is performed by the communication setup unit 302 of the first IP telephony device 502, as illustrated in FIG. 3.

The information could be received in many different ways. The customer could call up a contact list and select a person on the contact list, or a telephone number that is displayed on the contact list. The customer might also utilize a keypad to input a telephone number associated with the second IP telephony device 532, or to input a name or other form of identifier for the user of the second IP telephony device 532. The customer might also speak the name of the user of the second IP telephony device 532, and speech recognition assets on the first IP telephony device 502 or elsewhere could be used to interpret the customer's spoken input. Regardless, information is acquired in step S602 that allows the customer's telephony device 502 to determine an identifier or telephone number of the second IP telephony device 532 to which the customer wishes to place a call.

In step S604, the communication setup unit 302 of the first IP telephony device 502 determines which of the identifiers assigned to the first IP telephony device 502 should be used for purposes of the outgoing call. As explained above, we wish to use an identifier that is associated with the country where the called telephony device is located. Thus, in step S604 the information received in step S602 is used to determine the country where the called telephony device is located. In this case, that is the second country, where the second IP telephony device 532 is located.

The communication setup unit 302 of the first IP telephony device 502 then consults a device identifier database 304 to determine if an identifier associated with the second country has been assigned to the first IP telephony device 502. As explained above, an identifier associated with the second country has been assigned to the first IP telephony device 502. Thus, in step S604, this identifier is used to identify the first IP telephony device 502 as the originator or calling party for purposes of the call to the second IP telephony device 532.

If no identifier associated with the second country had been assigned to the first IP telephony device, a default identifier that has been assigned to the first IP telephony device 502 could be used for the outgoing call. In other embodiments, where multiple identifiers have been assigned to the first IP telephony device 502, step S604 could involve selecting the identifier that will result in the lowest possible charge being assessed to the customer for completing the call.

For example, assume a scenario where a first identifier associated with the first country and a second identifier associated with a third country have been assigned to the first IP telephony device 502, but no identifier associated with the second country has been assigned to the first IP telephony device 502. If a customer using the first IP telephony device 502 wishes to set up a communication with the second IP telephony device 532 in the second country, either of the first and second identifiers could be used as the originating identifier.

Because neither of the first and second identifiers is associated with the second country, it may make the best sense to select the identifier which will result in the lowest charges to the customer for setting up the communication. If the lowest charges to the customer will result from using the first identifier as the originating identifier, then the first identifier is used. If the lowest charges to the customer will result from using the second identifier (associated with a third country) as the originating identifier, then the second identifier is used.

On the other hand, it may instead make sense to select an identifier based on costs which may be incurred by the called party, in this case, the user of the second IP telephony device 532 located in the second country. When the customer using the first IP telephony device places a telephone call to the individual using the second IP telephony device, the originating identifier appearing in the caller ID information will likely be at least temporarily recorded in a memory of the second IP telephony device 532. If the user of the second IP telephony device 532 later wishes to call the customer using the first IP telephony device 502, the user of the second IP telephony device 532 can dial the telephone number which has been recorded in the memory of the second IP telephony device 532. As explained above, this could be a first identifier associated with the first country, or a second identifier associated with a third country.

If the user of the second IP telephony device 532 would be charged less for setting up a communication directed to the first identifier, as opposed to the second identifier, then it would be good for the first identifier to be recorded in the memory of the second IP telephony device 532. Which means the original communication from the first IP telephony device 502 to the second IP telephony device 532 should use the first identifier as the originating identifier.

On the other hand, if the user of the second IP telephony device 532 would be charged less for setting up a communication directed to the second identifier, as opposed to the first identifier, then it would be good for the second identifier to have been recorded in the memory of the second IP telephony device 532. Which means the original communication from the first IP telephony device 502 to the second IP telephony device 532 should use the second identifier as the originating identifier.

Thus, for the reasons explained above, when a first party is setting up a communication to a second party, the originating identifier selected for the outgoing communication may be based on the costs which would be incurred by the second party when the second party later is attempting to set up an outgoing communication directed back to the first party.

In still other embodiments of the invention, the party setting up the outgoing communication may have the option of selecting the originating identifier that is to be used for the communication. This could be accomplished in multiple different ways.

In some instances, the user may have the option of selecting the originating identifier that is used for each outgoing communication. Part of the process of requesting the setup of the communication could include providing an indication of the originating identifier that is to be used. For example, a software application on the user's telephony device could present the user with selectable options. The options that are presented to the user could be drawn from information stored on the telephony device itself, or from information that resides with the IP telephony system that will setup the communication.

In other instances, the user may be capable of specifying preferences as to which originating identifier is to be used in certain circumstances. For example, the user could indicate that whenever outgoing communications are being setup to countries A, B and C, a first originating identifier is to be used, but for all other countries, a second originating identifier is to be used. Those user preferences could be stored on the user's telephony device, by an IP telephony system, or in both locations.

In step S606, the first IP telephony device 502 interacts with elements of an IP telephony system and/or with the called telephony device, in this case the second IP telephony device 532, to setup and conduct the call. A brief description of several ways in which this could occur is provided below.

In some instances, the first IP telephony device 502 sends a call setup request to a first proxy server 516 of a first IP telephony system 510, which is the IP telephony system that provides the first IP telephony device 502 with service. The call setup request could be transmitted via an access point 504 and the Internet 506. The access point 504 could be a hard wired or wireless device that provides the first IP telephony device 502 with access to the Internet 506.

The first proxy server 516 consults an internal routing table, or a separate routing engine of the first IP telephony system 510, to determine the identity of a second proxy server 518 which is capable of terminating the call to the second IP telephony device 532. The first proxy server 516 then passes the call setup request to the second proxy server 518. The second proxy server 518 passes along the call setup request in any of multiple different ways.

In some instances, the second proxy server 518 could forward the call setup request to a second IP telephony system 540 located in the second country, and which is partnered with the first IP telephony system 510 for purposes of terminating calls to IP telephony devices in the second country. As illustrated in FIG. 5, the second proxy server 518 forwards the call setup request to a gateway or proxy server 542 of the second IP telephony system 540, and the gateway or proxy server 542 sends the call setup request on to the second IP telephony device 532 via the Internet 506 and an access point 530 which provides the second IP telephony device 532 with access to the Internet 506.

Alternatively, the second proxy server 518 could send the call setup request to a gateway 522 located in the second country and which is owned and/or controlled by the first IP telephony system 510. The gateway 522 then forwards the call setup request to the second IP telephony device 532 via the Internet 506 and the access point 530.

In still other instances, the second proxy server 518 could simply forward the call setup request directly to the second IP telephony device 532 via the Internet 506 and the access point 530.

The second IP telephony device then responds to the call setup request with signaling that traverses the same or a similar path back to the first IP telephony system 510 and ultimately the first IP telephony device 502. Assuming the second IP telephony device 532 is available, and the user of that device wishes to accept the call, the call commences and media of the call begins to flow back and forth between the first IP telephony device 502 and the second IP telephony device 532 until one party terminates the call.

Data packets bearing the media of the call could traverse a different path than the call setup signaling. During call setup, the first IP telephony device 502 and the second IP telephony device 532 may be instructed to exchange data packets bearing the media of the call via a media relay, or directly between each other. For example, as illustrated by the dashed lines in FIG. 5, data packets bearing the media of the call may be relayed back and forth through a media relay 520 that is owned and/or operated by the first IP telephony system 510. Alternatively, data packets bearing the media of the call may be relayed through a media relay 544 that is operated by the second IP telephony service provider 540 located in the second country. In yet other embodiments, media of the call could traverse a peer-to-peer path between the first IP telephony device 502 and the second IP telephony device 532, without passing through any media relays.

If the customer wishes to setup a call to an analog telephony device 552 in the second country, instead of the second IP telephony device 532, a different call flow may be implemented to place the call. The call flow would remain the same until the call setup request reaches the second proxy server 518. At that point, the second proxy server 518 sends the call setup request to a second PSTN 550 located in the second country, via the Internet 506. This could include sending the call setup request to a gateway operated by the second PSTN 550. Alternatively, the second proxy server 518 could send the call setup request to a gateway 522 in the second country. The gateway 522 then sends the call setup request to the second PSTN 550 via the Internet 506. The second PSTN 550 then terminates the call to the analog telephony device 552 in the second country.

A similar path could be used to terminate the call to the cellular telephony device 554, although the call setup request would be sent to a mobile telephony service provider 550 in the second country that would then terminate the call to the cellular telephony device 554.

Calls that are placed from a telephony device located in the second country to the first IP telephony device 502 could follow a similar call flow, but in reverse. However, one of the advantages in such a system is that people in the second country will be dialing a telephone number that is local to the second country in order to reach the first IP telephony device 502 in the first country. For this scheme to work, however, telephony systems in the second country must know that the telephone number that is local to the second country is actually tied to the first IP telephony device 502, or at least that calls to that number should be forwarded to the first IP telephony system 510 for termination.

If the first IP telephony system 510 enters into an agreement with a PSTN or mobile telephony service provider 550 in the second country, or the second IP telephony system 540 in the second country, the systems and methods described above become possible. Under such an agreement, the second PSTN or mobile telephony service provider 550 or the second IP telephony system 540 provide the first IP telephony system 510 with a group of telephone numbers from the second country which the first IP telephony system 510 can assign to its customers' telephony devices. Thereafter, whenever the second PSTN or mobile telephony service provider 550 or the second IP telephony system 540 in the second country receive a call setup request directed to one of those telephone numbers, the second PSTN or mobile telephony service provider 550 or the second IP telephony system 540 knows to forward the call to the first IP telephony system 510.

When the first IP telephony system 510 receives a call setup request directed to an identifier from a different geographical region, such as a telephone number from a different country, a communication setup unit 402 of the IP telephony system 510 consults a device identifier database 404, as illustrated in FIG. 4, to determine the identity of the telephony device assigned that foreign identifier. The device identifier database 404 cross-references identifiers from other geographical regions which have been assigned to customers' telephony devices to one or more identifiers of the customers' telephony devices. For example, a telephone number from the second country which has been assigned to the first IP telephony device 502 could be cross-referenced to a unique device identification number of the first IP telephony device 502, and/or to a first identifier from the first country that is assigned to the first IP telephony device 502.

Once the communication setup unit 402 of the first IP telephony system 510 determines the identity of the IP telephony device that has been assigned the foreign identifier in the incoming call setup request, the communication setup unit 402 of the first IP telephony system 510 terminates the call to the telephony device. This method of terminating communications allows individuals in the second country to dial a local telephone number to reach a customer of the first IP telephony system 510. In most instances, this ensures that the individual in the second country will not pay international long distance rates for placing the call.

It is relatively inexpensive for the second PSTN or mobile telephony service provider 550 or the second IP telephony system 540 to route such calls to the first IP telephony system 510 over a data network. Also, once the call has been received by the first IP telephony system 510 for termination, it typically costs no more to terminate the call to one of its customer's telephony devices than it would for any other type call. Thus, the cost of operating in this fashion is quite low for both telephony service providers.

Moreover, even if the first IP telephony device 502 is presently located in a third country, so long as the first IP telephony device 502 has access to the Internet, and can register with the first IP telephony system 502 over the Internet, incoming calls that originate in either of the first and second countries can be terminated to the first IP telephony device 502. And the cost to the first IP telephony system 510 of terminating the call should be essentially the same as if the first IP telephony device 502 was located in the first country. Thus, individuals in the second country can place a call to the first IP telephony device 502 for local rates, regardless of where the first IP telephony device 502 is actually located.

In the examples given above, the first IP telephony device 502 is assigned a first identifier from the first country, and a second identifier from the second country. However, additional identifiers from other geographical regions or countries could also be assigned to the first IP telephony device 502.

When a customer of an IP telephony system located in a first geographical region that is configured to operate as described above wishes to setup a telephony communication to an identifier or telephone number from a second geographical region, and the customer's telephony device has been assigned its own identifier from that second geographical region, the IP telephony system may be capable of terminating the call such that the local termination rates in the second geographical region are charged to the customer. FIG. 7 illustrates steps of a method 700 that is performed by an IP telephony system to accomplish this type of communication setup and billing. A description of this method is provided below with references to FIGS. 5 and 7.

The method 700 begins and proceeds to step S702, wherein a first proxy server 516 of the first IP telephony system 510 receives a call setup request from the first IP telephony device 502. The call setup request includes a called party identifier from the second country which is assigned to the second IP telephony device 532. The call setup request also includes a calling party identifier which is an identifier from the second country, and which has been assigned to the first IP telephony device 502. This means that the first IP telephony device 502 knows that it has been assigned an identifier from the second country, and that it is placing a call to an identifier in the second country. For these reasons, the first IP telephony device 502 chooses to use the assigned identifier from the second country as the originating identifier in the call setup request, as opposed to an identifier from the first country, which is likely the first IP telephony device's default identifier.

In step S704, the first IP telephony system 510 assists in setting up the call to the second IP telephony device 532 using any of the methods described above. When the call is terminated, in step S706 the first IP telephony system 510 charges the customer's account for the cost of placing a local call within the second country. This would be the cost of completing a call that originates and terminates from telephony devices in the second country. This is likely to be considerably less than the international long distance charges which would otherwise apply for a call placed from the first IP telephony device 502 in the first country to the second IP telephony device 532 in the second country.

FIG. 8 illustrates an alternate method 800 that is performed by the first IP telephony system 510 to assist the first IP telephony device 502 in setting up a communication to the second IP telephony device 532 in the second country, and for billing the customer for the call.

The method 800 begins and proceeds to step S802, wherein the first proxy server 516 of the first IP telephony system 510 receives a call setup request from the first IP telephony device 502. The call setup request includes a called party identifier of the second IP telephony device 532 located in the second country. However, in this method, the call setup request does not include a calling party identifier that is an identifier from the second country assigned to the first IP telephony device 502.

In step S804, a communication setup unit 402 of the first IP telephony system 510 consults a device identifier database 404 to determine if an identifier from the second country has been assigned to the first IP telephony device 502. If the communication setup unit 402 finds that an identifier from the second country has been assigned to the first IP telephony device 502, the communication setup unit 402 inserts this identifier into the call setup request as the calling party identifier. If not, an identifier from an alternate country will be inserted into the call setup request as the calling party identifier. The identifier that is ultimately used may be selected based on the cost which will be charged to the customer, or based on other cost considerations, as discussed above. In step S806, the first IP telephony system assists in setting up the request communication between the first IP telephony device 502 and the second IP telephony device 532 using any of the methods described above.

When the communication is terminated, in step S808 the first IP telephony system 510 charges the customer's account for the cost of placing a local call within the second country. This would be the cost of completing the call that originates and terminates from telephony devices in the second country.

In the methods described above in connection with FIGS. 7 and 8, a first IP telephony device 502 sets up and conducts a communication with the second IP telephony device 532 in the second country. In alternate embodiments, the communication could instead be directed to an analog telephony device 552 in the second country, or a cellular telephony device 554 in the second country, which are reachable via a PSTN or mobile telephony service provider 550 in the second country. Moreover, the first IP telephony device 502 need not be located in the first country for these methods to be performed. The first IP telephony device could itself be located in the second country, or it could be located in yet a third country.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for charging a user for an outgoing telephony communication that originates from a telephony device that is assigned multiple identifiers associated with different geographical regions, comprising:
receiving a telephony communication setup request from the telephony device that is assigned multiple identifiers associated with different geographical regions, wherein the setup request includes an identifier of the intended recipient of the communication;
assisting in the setup of the telephony communication; and
charging the user for the telephony communication based on rates that have been established for communications that originate from the geographical region associated with an originating identifier that is used for the telephony communication and that terminate in the geographical region associated with the identifier of the intended recipient.

2. The method of claim 1, wherein the receiving step comprises receiving a communication setup request from the telephony device that includes the originating identifier that is to be used for the telephony communication.

3. The method of claim 1, wherein the assisting step comprises:
determining a geographical region that is associated with the identifier of the intended recipient; and
selecting an originating identifier that is to be used for the telephony communication from the multiple identifiers assigned to the telephony device based, at least in part, on the determined geographical region.

4. The method of claim 3, wherein selecting an originating identifier comprises selecting the originating identifier based on the relative costs of setting up the telephony communication using each of the multiple identifiers assigned to the telephony device.

5. The method of claim 3, wherein selecting an originating identifier comprises selecting the originating identifier based on the relative costs that would be incurred by the intended recipient of the telephony communication to set up a new telephony communication directed to each of the multiple identifiers assigned to the telephony device.

6. The method of claim 1, wherein the assisting step comprises sending a call setup request to a gateway or proxy server that is capable of terminating the telephony communication to the intended recipient.

7. The method of claim 1, wherein the assisting step comprises sending a call setup request to a telephony service provider in the determined geographical region associated with the identifier of the intended recipient.

8. The method of claim 7, wherein the telephony service provider is a publically switched telephone network or a cellular telephony service provider in the determined geographical region associated with the identifier of the intended recipient.

9. A system for charging a user for an outgoing telephony communication that originates from a telephony device that is assigned multiple identifiers associated with different geographical regions, comprising:
means for receiving a telephony communication setup request from a telephony device that is assigned multiple identifiers associated with different geographical regions, wherein the setup request includes an identifier of the intended recipient of the communication;
means for assisting in the setup of the telephony communication; and
means for charging the user for the telephony communication based on rates that have been established for communications that originate from the geographical region associated with an originating identifier that is used for the telephony communication and that terminate in the geographical region associated with the identifier of the intended recipient.

10. A system for charging a user for an outgoing telephony communication that originates from a telephony device that is assigned multiple identifiers associated with different geographical regions, comprising:
a communication setup unit that receives a telephony communication setup request from a telephony device that is assigned multiple identifiers associated with different geographical regions, wherein the setup request includes an identifier of the intended recipient of the communication, the communication setup unit also assisting in the setup of the telephony communication; and
a billing unit that charges the user for the telephony communication based on rates that have been established for communications that originate from the geographical region associated with an originating identifier that is used for the telephony communication and that terminate in the geographical region associated with the identifier of the intended recipient.

11. The system of claim 10, wherein the communication setup unit receives a communication setup request from the telephony device that includes the originating identifier that is to be used for the telephony communication.

12. The system of claim 10, wherein the communication setup unit determines a geographical region that is associated with the identifier of the intended recipient and selects an originating identifier that is to be used for the telephony communication from the multiple identifiers assigned to the telephony device based, at least in part, on the determined geographical region.

13. The system of claim 12, wherein the communication setup unit selects the originating identifier based on the relative costs of setting up the telephony communication using each of the multiple identifiers assigned to the telephony device.

14. The system of claim 12, wherein the communication setup unit selects the originating identifier based on the relative costs that would be incurred by the intended recipient of the telephony communication to set up a new telephony communication directed to each of the multiple identifiers assigned to the telephony device.

15. The system of claim 10, wherein the communication setup unit sends a call setup request to a gateway or proxy server that is capable of terminating the telephony communication to the intended recipient.

16. The system of claim 10, wherein the communication setup unit sends a call setup request to a telephony service provider in the determined geographical region associated with the identifier of the intended recipient.

17. The system of claim 16, wherein the telephony service provider is a publically switched telephone network or a cellular telephony service provider in the determined geographical region associated with the identifier of the intended recipient.
